(19) United States
(12) Patent Application Publication
(10) Pub. No.: US 2024/0410652 A1
(43) Pub. Date: Dec. 12, 2024

(54) HEAT TREATMENT FURNACE

(71) Applicant: NGK INSULATORS, LTD., Nagoya-Shi (JP)

(72) Inventors: Takeshi KOMAKI, Nagoya-Shi (JP); Takuma MATSUMOTO, Handa-Shi (JP)

(73) Assignee: NGK INSULATORS, LTD., Nagoya-Shi (JP)

(21) Appl. No.: 18/734,055

(22) Filed: Jun. 5, 2024

(30) Foreign Application Priority Data
Jun. 6, 2023 (JP) 2023-093275

(51) Int. Cl. F27B 9/24; F27B 9/06; F27B 9/30

(52) U.S. Cl. CPC F27B 9/2407; F27B 9/062; F27B 9/30

(57) ABSTRACT

A heat treatment furnace may include: a furnace body including an entrance, an exit and a processing chamber; a conveyor configured to convey a sheet-shaped object extending from the entrance to the exit; and a heating device configured to heat the object being conveyed by the conveyor. The heating device may include one or more heaters each including a heating part configured to radiate infrared electromagnetic waves to the object. The one or more heaters may be disposed along a conveying path of the object. The heating part may be disposed parallel to a front or back surface of the object, and may extend in a width direction of the object orthogonal to the conveying path. When a widthwise dimension of the object is Wd and a widthwise dimension of the heating part is Hd, Wd/Hd may be in a range of 0.20 to 0.80.

### REFERENCE TO RELATED APPLICATION

The present application claims priority to Japanese Patent Application No. 2023-093275, filed on Jun. 6, 2023, the entire contents of which are incorporated herein by reference.

### TECHNICAL FIELD

The technology disclosed herein relates to a heat treatment furnace that performs heat treatment on an object.

### BACKGROUND ART

In a heat treatment furnace described in International Publication No. 2014/163175, an object to be treated extends from an entrance to an exit through a treatment chamber. The object is conveyed into the processing chamber from the entrance, heat treated while being conveyed through the processing chamber, and conveyed out from the exit. In this heat treatment furnace, the object is guided by a plurality of guide rollers located in the processing chamber, and the object is conveyed along a predetermined conveying path in the processing chamber.

### SUMMARY

In this type of heat treatment furnace, there is a need to improve its heat treatment performance (e.g., dehydration rate in a drying furnace) in order to increase productivity. In addition, a heat treatment furnace with even better energy-saving performance is required from a zero-emission perspective. Generally, in order to improve the heat treatment performance, increasing output of the heater and applying more heat energy to an object to be treated can be considered. However, simply increasing the output of the heater may excessively increase a temperature of the object, resulting in deterioration of the quality of the object. In addition, even if the heat treatment performance is improved by increasing the output of the heater, the energy-saving performance would be reduced if the heat energy from the heater cannot be used efficiently for heat treatment. This disclosure discloses technology related to a heat treatment furnace which has excellent energy-saving performance and improves heat treatment performance while suppressing a temperature increase of an object.

A heat treatment furnace disclosed herein may comprise: a furnace body including an entrance, an exit and a processing chamber disposed between the entrance and the exit; a conveyor configured to convey a sheet-shaped object from the entrance through the processing chamber to the exit, the object extending from the entrance to the exit; and a heating device disposed in a space in the processing chamber in which the object is conveyed and configured to heat the object being conveyed by the conveyor. The heating device may comprise one or more heaters each including a heating part configured to radiate infrared electromagnetic waves to the object. The one or more heaters may be disposed along a conveying path of the object. The heating part may be disposed parallel to a front or back surface of the object, and may extend in a width direction of the object orthogonal to the conveying path. When a widthwise dimension of the object is Wd and a widthwise dimension of the heating part is Hd, Wd/Hd may be in a range of 0.20 to 0.80.

### BRIEF DESCRIPTION OF DRAWINGS

FIG. 1 illustrates a longitudinal sectional view of a heat treatment furnace of an embodiment.

FIG. 2 illustrates a cross-sectional view taken along II-II line of FIG. 1.

FIG. 3 illustrates a cross-sectional view of a heater of the embodiment.

FIG. 4 illustrates a cross-sectional view of a gas supply pipe of the embodiment.

FIG. 5 schematically illustrates a relationship between dimensions within the furnace, a widthwise dimension of a workpiece, and dimensions of the heater.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved heat treatment furnaces, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

A heat treatment furnace disclosed herein may comprise: a furnace body including an entrance, an exit and a processing chamber disposed between the entrance and the exit; a conveyor configured to convey a sheet-shaped object from the entrance through the processing chamber to the exit, the object extending from the entrance to the exit; and a heating device disposed in a space in the processing chamber in which the object is conveyed and configured to heat the object being conveyed by the conveyor. The heating device may comprise one or more heaters each including a heating part configured to radiate infrared electromagnetic waves to the object. The one or more heaters may be disposed along a conveying path of the object. The heating part may be disposed parallel to a front or back surface of the object, and may extend in a width direction of the object orthogonal to the conveying path. When a widthwise dimension of the object is Wd and a widthwise dimension of the heating part is Hd, Wd/Hd may be in a range of 0.20 to 0.80.

In the above heat treatment furnace, the one or more heaters of the heating device each include the heating part configured to radiate the infrared electromagnetic waves to the object. Therefore, the electromagnetic waves with wavelengths in an infrared range suitable for heat treatment can be radiated onto the object. The widthwise dimension of the heating part of the one or more heaters is optimized for the widthwise dimension of the object. That is, Wd/Hd is in the range of 0.20 to 0.80. As a result, the electromagnetic waves radiated from the heating part are effectively used for the heat treatment of the object, and the amount of electromagnetic waves used for purposes other than the heat treatment can be reduced. Therefore, heat treatment performance can be improved while a temperature increase of the object is suppressed, and energy-saving performance can also be improved.

In the heat treatment furnace disclosed herein, Wd/Hd may be in a range of 0.25 to 0.65. Further, Wd/Hd may be in a range of 0.30 to 0.50. According to this configuration, the energy-saving performance can be further improved and the heat treatment performance can further be improved.

In the heat treatment furnace disclosed herein, the furnace body may comprise a pair of sidewalls spaced apart in the width direction. The heating part may comprise a first end disposed near one of the pair of sidewalls and a second end disposed near another of the pair of sidewalls. When a distance between the first end and the one of the pair of sidewalls is Ld1, Wd/Ld1 may be in a range of 0.32 to 0.74, and when a distance between the second end and the other of the pair of sidewalls is Ld2, Wd/Ld2 may be in a range of 0.20 to 0.33. According to this configuration, the distances between the heating part and the sidewalls are optimized. The electromagnetic waves radiated from the heating part are effectively used for the heat treatment of the object, by which the energy-saving performance is improved and the heat treatment performance is increased. In addition, since the amount of electromagnetic waves used for purposes other than the heat treatment can be reduced, it is possible to suppress the sidewalls from reaching a high temperature due to the sidewalls being heated by the electromagnetic waves radiated from the heating part. As a result, it is possible to suppress the heating of the object (i.e., temperature increase of the object) by the radiation from the sidewalls.

In the heat treatment furnace disclosed herein, Wd/Ld1 may be in a range of 0.35 to 0.55, and Wd/Ld2 may be in a range of 0.23 to 0.25. According to this configuration, the energy-saving performance can be further improved and the heat treatment performance can further be increased.

The heat treatment furnace disclosed herein may further comprise a plurality of guide rollers disposed in the processing chamber and configured to guide the object conveyed by the conveyor. The conveying path may be defined by the plurality of guide rollers. According to this configuration, the length of the conveying path in the treatment chamber can be increased, by which the efficiency of heat treatment of the object can be improved.

In the heat treatment furnace disclosed herein, the object may comprise a sheet-shaped film and a paste applied to at least one of a front surface and a back surface of the film. The heating device may be configured to remove moisture contained in the paste. The film has a small dimension in the thickness direction, and an increase in a film temperature may cause deterioration of film quality. Therefore, the heat treatment furnace disclosed herein can be used to improve the heat treatment performance (moisture removal rate) and to suppress the increase in film temperature.

### EMBODIMENTS

A heat treatment furnace 10 of an embodiment will be described. The heat treatment furnace 10 of the present embodiment is a drying furnace (dehydrating device) configured to remove moisture contained in a workpiece W (an example of an object). The workpiece W is a sheet continuously extending in the longitudinal direction. For example, a film used for a liquid crystal display, an organic EL, a battery, and the like, can be the workpiece W. Such a film (a sheet) may contain moisture in the film itself, or when the film is coated with a coating layer, this coating layer may contain moisture. Therefore, the moisture contained in the film is first removed, and then the film from which moisture is removed is cut into a desired size to produce a final product. The heat treatment furnace 10 of the present embodiment can be used to remove moisture from such a sheet.

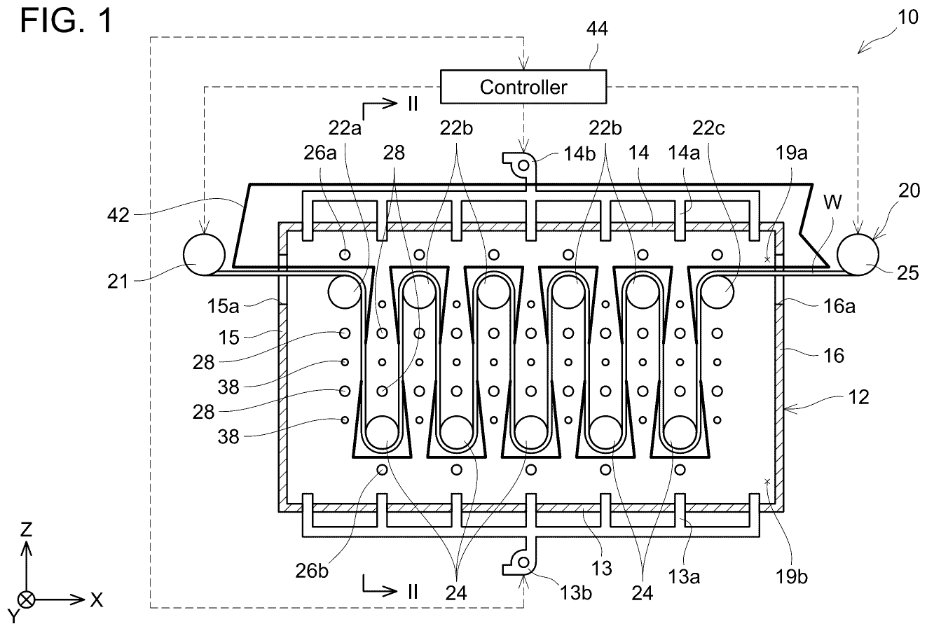

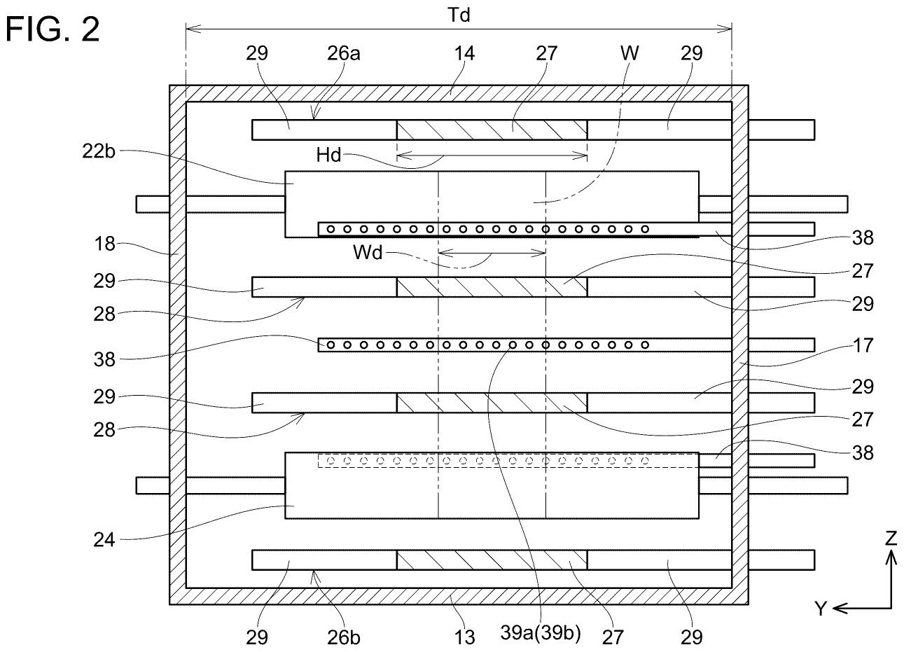

A configuration of the heat treatment furnace 10 will be described below with reference to the drawings. As illustrated in FIGS. 1 and 2, the heat treatment furnace 10 includes a cuboid-shaped furnace body 12, a conveyor 20 configured to convey the workpiece W into and out of the furnace body 12, heating devices (26, 28) configured to heat the workpiece W, and gas supply devices (38, etc.) configured to supply cooling gas to surfaces of workpiece W.

The furnace body 12 includes a lower wall 13, an upper wall 14 opposite the lower wall 13, sidewalls 17 and 18 (see FIG. 2) whose one ends are connected to the lower wall 13 and the other ends are connected to the upper wall 14, and an entrance wall 15 and an exit wall 16 which close the ends of a processing chamber (19a, 19b) enclosed by these walls 13, 14, 17, 18.

The lower wall 13 is a rectangular plate material in the plan view and is located at a lower portion of the processing chamber (19a, 19b). As illustrated in FIG. 1, the lower wall 13 includes a plurality of exhaust ports 13a at a substantially regular interval in the x direction. Among the plurality of exhaust ports 13a, five exhaust ports 13a arranged in the center are at positions facing guide rollers 24 to be described later. Among the plurality of exhaust ports 13a, the exhaust port 13a disposed at one end in the x direction is at a position close to the entrance wall 15. Among the plurality of exhaust ports 13a, the exhaust port 13a disposed at the other end in the x direction is at a position close to the exit wall 16. Each of the plurality of exhaust ports 13a is connected to an exhaust fan 13b. When the exhaust fan 13b operates, an ambient gas in the processing chamber (19a, 19b) is exhausted out of the processing chamber (19a, 19b).

The upper wall 14 is a plate material of the same shape as the lower wall 13 and is located at an upper portion of the processing chamber (19a, 19b). As with the lower wall 13, the upper wall 14 also includes a plurality of exhaust ports 14a spaced at a substantially regular interval in the x direction. Each of the plurality of exhaust ports 14a is at a position facing corresponding one of the plurality of exhaust ports 13a. Each of the plurality of exhaust ports 14a is connected to an exhaust fan 14b. When the exhaust fan 14b operates, the ambient gas in the processing chamber (19a, 19b) is exhausted out of the processing chamber (19a, 19b).

The entrance wall 15 includes an entrance 15a and an exit 16a is defined in the exit wall 16. Height-wise positions of the entrance 15a and the exit 16a are the same, and the entrance 15a and the exit 16a face each other. As is clear from FIG. 1, the processing chamber (19a, 19b) is located between the entrance 15a and the exit 16a.

The inner surface of each of the walls 13, 14, 15, 16, 17, 18 (i.e., a surface on the processing chamber (19a, 19b) side) that constitutes the furnace body 12 is given mirror finish. As a result, a reflectance of infrared electromagnetic waves (specifically, electromagnetic waves radiated by heaters 26, 28 to be described later) on these surfaces is equal to or greater than 50%. Consequently, the electromagnetic waves radiated by the heaters 26, 28 can be emitted to the workpiece W efficiently.

The conveyor 20 includes: an entrance roller 21 located outside the furnace body 12 and close to the entrance 15a; an exit roller 25 located outside the furnace body 12 and close to the exit 16a; and a plurality of guide rollers (22a, 22b, 22c, 24) located in the processing chamber (19a, 19b).

A workpiece W is strapped on the entrance roller 21. The workpiece W strapped on the entrance roller 21 extends from the entrance 15a through the processing chamber (19a, 19b) to the exit 16a. Specifically, the workpiece W extends from the entrance roller 21 through the entrance 15a to the guide rollers (22a, 22b, 22c, 24) and further extend from the guide rollers (22a, 22b, 22c, 24) through the exit 16a to the exit roller 25.

The exit roller 25 is a roller that winds up the workpiece W conveyed out of the processing chamber (19a, 19b). A drive device (not illustrated) is connected to the exit roller 25, and the drive device rotates the exit roller 25. When the exit roller 25 rotates, the workpiece W that is strapped on the entrance roller 21 is fed into the processing chamber (19a, 19b). The workpiece W fed from the entrance roller 21 is guided by the guide rollers (22a, 22b, 22c, 24) and moves along a predetermined conveying path in the processing chamber (19a, 19b), then sent out of the processing chamber (19a, 19b) from the exit 16a and strapped onto the exit roller 25. In other words, the guide rollers (22a, 22b, 22c, 24) define the conveying path of the workpiece W in the processing chamber (19a, 19b).

The guide rollers (22a, 22b, 22c, 24) include a plurality of upper guide rollers (22a, 22b, 22c) located close to the upper wall 14 and a plurality of lower guide rollers (24) located close to the lower wall 13. In the present embodiment, the guide rollers (22a, 22b, 22c, 24) are contact rollers that are in contact with the workpiece W, however, non-contact rollers that guide the workpiece W without contact can also be used.

The upper guide rollers (22a, 22b, 22c) are arranged at a regular interval in the x direction. Specifically, the upper guide roller 22a is located adjacent to the entrance 15a, and the upper guide roller 22c is located adjacent to the exit 16a. The plurality of guide rollers 22b is positioned at an equal interval between the upper guide rollers 22a and 22c. Heightwise positions of the upper guide rollers (22a, 22b, 22c) are the same.

As with the upper guide rollers (22a, 22b, 22c), each of the plurality of lower guide rollers 24 is spaced at a regular interval in the x-direction. The interval of the adjacent lower guide rollers 24 in the x-direction is the same as the interval of the upper guide rollers (22a, 22b, 22c) in the x-direction. A position of each of the plurality of lower guide rollers 24 in the x-direction is the center position of a corresponding pair of adjacent upper guide rollers (22a, 22b, 22c). The height-wise positions of the plurality of lower guide rollers 24 are the same.

Since the upper guide rollers (22a, 22b, 22c) and the lower guide roller 24 are arranged as described above, the workpiece W conveyed in the x direction from the entrance 15a is conveyed downward by the upper guide roller 22a, then conveyed upward by the lower guide roller 24, and then the workpiece W is repeatedly conveyed upward and downward by the upper guide rollers 22b and the lower guide rollers 24. The workpiece W that is conveyed upward from the lower guide roller 24 closest to the exit 16a is conveyed toward the exit 16a by the upper guide roller 22c. In this way, the workpiece W is repeatedly conveyed in the processing chambers (19a, 19b) upward and downward, by which the space in the processing chambers (19a, 19b) can be efficiently used and a processing time to dry the workpiece W is secured. As is clear from FIG. 1, the processing chamber (19a, 19b) is divided into an upper processing chamber (19a) on the upper wall 14 side and a lower processing chamber (19b) on the lower wall 13 side by the workpiece W extending on the guide rollers (22a, 22b, 22c, 24).

The heating device is located in the processing chamber (19a, 19b) and configured to heat the workpiece W conveyed by the conveyor 20. The heating device includes first heaters (26a, 26b) located near the guide rollers (22a, 22b, 22c, 24) and second heaters 28 located at a height between the upper guide rollers (22a, 22b, 22c) and the lower guide roller 24. As illustrated in FIG. 1, the first heaters (26a, 26b) and the second heater 28 are arranged along the conveying path of the workpiece W.

The first heaters (26a, 26b) include a plurality of first upper heaters 26a disposed above the upper guide rollers (22a, 22b, 22c) and a plurality of first lower heaters 26b disposed below the lower guide rollers 24. Each of the first upper heaters 26a is disposed to face its corresponding upper guide roller (22a, 22b, 22c), and each of the first lower heaters 26b is disposed to face its corresponding lower guide roller 24. Thus, the workpiece W is positioned between the first upper heaters 26a and the upper guide rollers (22a, 22b, 22c), and the workpiece W is directly heated by the first upper heaters 26a. Similarly, the workpiece W is positioned between the first lower heaters 26b and the lower guide rollers 24, and the workpiece W is directly heated by the first lower heater 26b.

Two second heaters 28 are located below each of the upper guide rollers (22a, 22b, 22c), and spaced apart in the z-direction. In addition, two second heaters 28 are located above each of the lower guide rollers 24, and spaced apart in the z-direction. Thus, eleven second heaters 28 are arranged and spaced apart in the x-direction and two second heaters 28 are arranged and spaced apart in the z-direction. As is clear from the figure, the second heaters 28 are positioned to face the workpiece W extending on the upper guide rollers (22a, 22b, 22c) and the lower guide roller 24 (i.e., near the middle position between the guide rollers adjacent in the conveying direction of the workpiece W). Since the second heaters 28 extends in the axial direction of the guide rollers (22a, 22b, 22c, 24), the entirety of the workpiece W in its width direction which extends on the upper guide rollers (22a, 22b, 22c) and the lower guide rollers 24 is heated by the second heaters 28.

As illustrated in FIG. 2, each of the first heaters (26a, 26b) and second heaters 28 extends in the processing chamber (19a, 19b) and penetrates through the sidewall 17. Each of the first heaters (26a, 26b) and the second heaters 28 is arranged parallel to the guide rollers (22a, 22b, 22c, 24) and extends in the axial direction (Y-direction) of the guide rollers (22a, 22b, 22c, 24). Each of the first heaters (26a, 26b) and the second heaters 28 includes a heating part 27 that radiates infrared electromagnetic waves (heat energy) and non-heating parts 29 that do not radiate infrared electromagnetic waves (heat energy). In other words, the heating parts 27 contribute to the heat treatment of the workpiece W, while the non-heating parts 29 do not contribute to the heat treatment of the workpiece W. In the heaters (26a, 26b, 28), a position in the axial direction (Y-direction) at which the heat energy is radiated can be adjusted by adjusting positions of the heating parts 27 in the axial direction (Y-direction).

As is clear from FIG. 2, in each of the heaters (26a, 26b, 28), the heating part 27 is at the center in the axial direction and the non-heating parts 29 are located at both ends in the axial direction. In other words, the heating part 27 is positioned between the two non-heating parts 29. In this embodiment, the position of the heating part 27 is adjusted to face the workpiece W guided by the guide rollers (22a, 22b, 22c, 24). Specifically, the center of the workpiece W in the width direction (Y-direction) is adjusted to coincide with the center of the heating part 27 in the width direction (Y-direction). Accordingly, the heating part 27 is disposed parallel to the front surface or the back surface of the workpiece W and faces the front surface or the back surface of the workpiece W, and radiates infrared electromagnetic waves (heat energy) to the front surface or the back surface of the workpiece W.

In this embodiment, when the widthwise (Y-direction) dimension of the workpiece W is Wd and the widthwise (Y-direction) dimension of each of the heating parts 27 is Hd, Wd/Hd is adjusted to be in a range of 0.20 to 0.80. In other words, by setting Wd/Hd to 0.80 or less, the widthwise (Y-direction) dimension Hd of the heating part 27 is made to be an appropriate length for the widthwise (Y-direction) dimension Wd of the workpiece W. Consequently, the entirety of the workpiece W in its width direction can be heated by the heating parts 27, and uneven heating of the workpiece W in the width direction can be prevented. Conversely, if Wd/Hd is made greater than 0.80, the edge of the workpiece W may not be sufficiently heated and moisture may not be removed from the edge of the workpiece W. In such a case, it is necessary to take a measure such as increasing the length of the conveying path of the workpiece W and/or reducing the conveying speed, as a result of which the energy-saving performance of the heat treatment furnace is decreased. On the other hand, by setting Wd/Hd to 0.2 or more, the widthwise (Y-direction) dimension Hd of the heating part 27 does not become too longer than the widthwise (Y-direction) dimension Wd of the workpiece W. Consequently, the electromagnetic waves radiated from the heating parts 27 can be effectively used for the heat treatment of the workpiece W, by which the energy-saving performance of the heat treatment furnace can be improved. Furthermore, the furnace body 12 (more precisely, the inner wall surfaces of the lower wall 13, upper wall 14, sidewalls 17, 18, entrance wall 15, and exit wall 16) can be suppressed from becoming hot by the electromagnetic waves radiated from the heating parts 27. Since the inner wall surfaces of the furnace body 12 can be suppressed from becoming hot, heating of the workpiece W by radiation from the inner wall surfaces of the furnace body 12 can be suppressed, and the workpiece W can be suppressed from becoming hot. Wd/Hd may be in the range of 0.25 to 0.65, or may be in the range of 0.30 to 0.50. Such a numerical range promotes effective use of the electromagnetic waves radiated from the heating parts 27, and energy-saving performance can be improved while heat treatment performance can further be improved.

When the distance between each of the heating parts 27 and the sidewall 17 (i.e., the sidewall 17 through which the heaters (26a, 26b, 28) penetrate) (more precisely, the distance from the end of the heating part 27 closer to the sidewall 17 (the end in the −Y-direction) to the sidewall 20) 17) is Ld1, Wd/Ld1 is adjusted to be in range of 0.32 to 0.74. Similarly, when the distance between each of the heating parts 27 and the sidewall 18 (i.e., the sidewall 18 through which the heaters (26a, 26b, 28) do not penetrate) (more precisely, the distance from the end of the heating part 27 close to the sidewall 18 (the end in the +Y-direction) to the sidewall 18) is Ld2, Wd/Ld2 is adjusted to be in the range of 0.20 to 0.33. In other words, by setting Wd/Ld1 to 0.32 or more, the distance between the heating part 27 and the sidewall 17 does not become too long. This can suppress the furnace body 12 from becoming too large and in turn suppress deterioration of the thermal efficiency (i.e., decrease in the energy-saving performance). Further, by setting Wd/Ld1 to 0.74 or less, the distance between the heating part 27 and the sidewall 17 does not become too short. This can suppress the furnace body 12 (more specifically, the inner wall surface of the sidewall 17) from becoming too hot by the electromagnetic waves radiated from the heating part 27. As a result, heating of the workpiece W by the radiation from the inner wall surface of the furnace body 12 can be suppressed, and the workpiece W can be suppressed from becoming hot. Similarly, by setting Wd/Ld2 to 0.20 or more, the distance between the heating part 27 and the sidewall 18 does not become too long. Further, by setting Wd/Ld2 to 0.33 or less, the distance between the heating part 27 and the sidewall 18 does not become too short. Consequently, the electromagnetic waves radiated from the heating part 27 can be effectively used for heat treatment of the workpiece W, and the energy-saving performance can be improved while the heat treatment performance is increased.

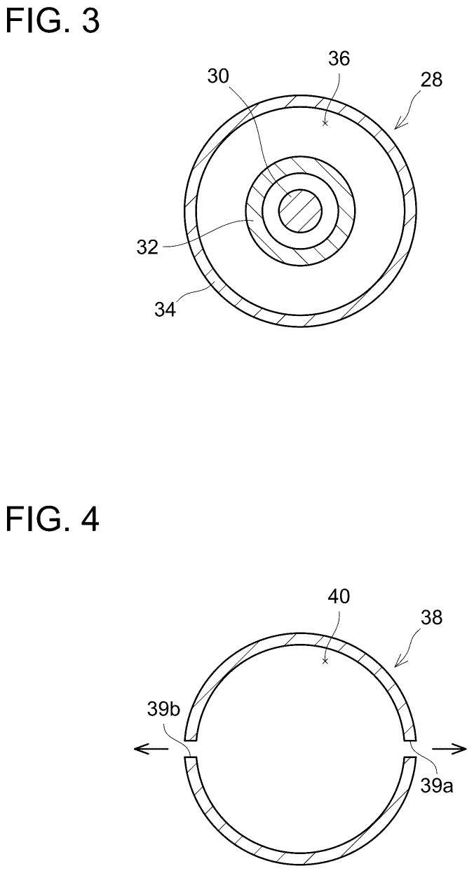

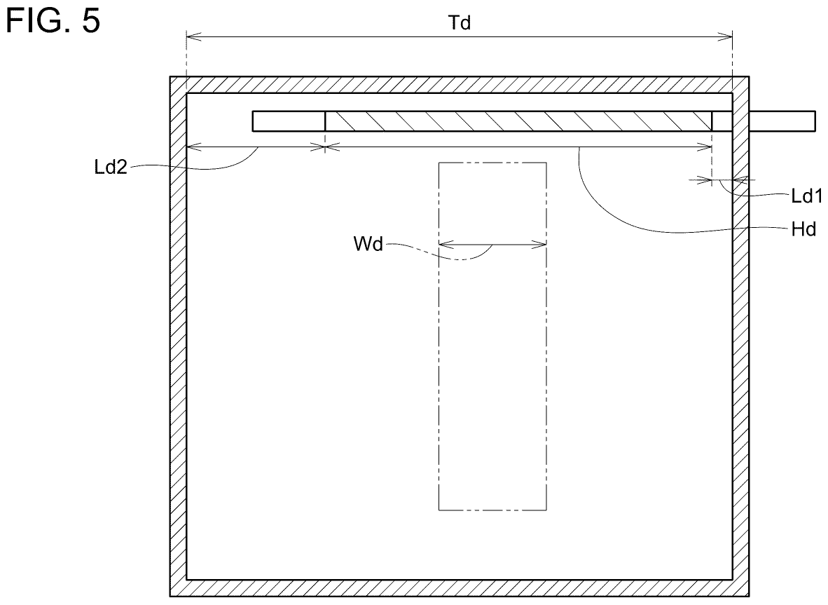

As is clear from the above numerical range, the distance Ld1 from the sidewall 17 to each of the heating parts 27 and the distance Ld2 from the sidewall 18 to each of the heating parts 27 may be the same, or the distance Ld1 from the sidewall 17 to the heating parts 27 may be shorter than the distance Ld2 from the sidewall 18 to the heating parts 27. For example, in this embodiment, the ends of the heaters (26a, 26b, 28) close to the sidewall 17 are located outside the furnace body 12 and refrigerant (e.g., air) is supplied thereto outside the furnace body 12 (see FIG. 2). As described below, each of the heaters (26a, 26b, 28) has a double-tube structure with an inner tube 32 and an outer tube 34, and the refrigerant is supplied to the space 36 between the inner tube 32 and the outer tube 34 (see FIG. 3). By supplying the refrigerant to the heaters (26a, 26b, 28) outside of the furnace body 12, excessive decrease of the temperature inside the furnace caused by the refrigerant is suppressed, by which decrease of the heat treatment performance is suppressed. Here, if the position of the heating part 27 is placed in the center of the axial direction of each of the heaters (26a, 26b, 28), the heating part 27 is positioned near the sidewall 17, and the distance Ld1 from the sidewall 17 to the heating part 27 becomes shorter than the distance Ld2 from the sidewall 18 to the heating part 27. The refrigerant supplied to the heaters (26a, 26b, 28) can be discharged from the ends on the sidewall 17 side.

Here, when the distance Ld1 from the sidewall 17 to each of the heating parts 27 is shorter than the distance Ld2 from the sidewall 18 to each of the heating parts 27, Wd/Ld1 may be in the range of 0.35 to 0.55 and Wd/Ld2 may be in the range of 0.23 to 0.25. By adjusting it to such a range, the electromagnetic waves radiated from the heating parts 27 can be used more effectively for heat treatment of the workpiece W, and the energy-saving performance of the heat treatment furnace 10 can further be improved. When the ends at which the refrigerant is supplied to the heaters (26a, 26b, 28) are the ends on the sidewall 18 side, the ends on the sidewall 18 side may be placed outside the furnace body 12 and the heating parts 27 may be placed near the sidewall 18 so that the distance Ld2 from the sidewall 18 to each of the heating parts 27 becomes shorter than the distance Ld1 from the sidewall 17 to each of the heating parts 27. In this case, Wd/Ld1 may be in the range of 0.20 to 0.33, preferably 0.23 to 0.25, and Wd/Ld2 may be in the range of 0.32 to 0.74, preferably 0.35 to 0.55. The ends of the heaters (26a, 26b, 28) to which the refrigerant is supplied and the ends from which the refrigerant is discharged may both be located inside the furnace body 12.

The first heaters (26a, 26b) are known wavelength-controllable heaters that radiates the infrared electromagnetic waves, and the heating parts 27 of the first heaters (26a, 26b) and the heating parts 27 of the second heaters 28 have the same structure. For this reason, the structure of the heating parts 27 of the second heaters 28 is briefly explained here.

As illustrated in FIG. 3, each second heater 28 includes a filament 30, an inner tube 32 that houses the filament 30, and an outer tube 34 that houses the inner tube 32. The filament 30 is for example a heating element made of tungsten and to which power from an external power source (not shown) is supplied. When the filament 30 is supplied with power and reaches a predetermined temperature (e.g., 1200 to 1700° C.), infrared electromagnetic waves are radiated from the filament 30. The inner tube 32 is constituted of an infrared-transmitting material that selectively transmits electromagnetic waves in a specific wavelength range (in this embodiment, the infrared range) among the electromagnetic waves radiated from the filament 30. By appropriately selecting the infrared-transmitting material that constitutes the inner tube 32, the wavelength of the electromagnetic waves radiated from the filament 30 to the outside of the inner tube 32 can be adjusted to the desired wavelength. The outer tube 34 is also constituted of the same infrared-transmitting material as the inner tube 32. Therefore, the electromagnetic waves transmitted through the inner tube 32 are radiated to the outside through the outer tube 34. The space 36 between the inner tube 32 and the outer tube 34 is a refrigerant flow path through which the refrigerant (e.g., air) flows. The supply of refrigerant to the space 36 (i.e., the refrigerant flow path) prevents the temperature of the outer tube 34 from becoming too hot. This prevents the workpiece W from overheating. The wavelength-controllable heaters that radiates infrared electromagnetic waves are disclosed in detail, for example, in Japanese Patent No. 4790092.

The gas supply devices include a plurality of gas supply pipes 38 extending in the processing chamber (19a, 19b) in the Y-direction and a gas supply fan (not illustrated) located outside the processing chamber (19a, 19b) and configured to supply cooling gas to the plurality of gas supply pipes 38. As illustrated in FIG. 4, the gas supply pipe 38 has injection holes 39a and 39b defined at two locations in the circumferential direction. Therefore, cooling gas supplied to the gas supply pipe 38 from the gas supply fan is injected into the processing chamber (19a, 19b) through the injection holes 39a, 39b. In this embodiment, the orientation of the gas supply pipe 38 is adjusted so that the direction of the cooling gas injected from the injection holes 39a, 39b is orthogonal to the surfaces of the workpiece W. As illustrated in FIG. 4, the injection holes 39a, 39b are at positions facing each other across the axis of the gas supply pipe 38. Therefore, when the workpiece W is positioned both on the entrance 15a side and the exit 16a side of the gas supply pipe 38, the cooling gas injected through the injection holes 39a of this gas supply pipe 38 is injected the workpiece W on one side, and the cooling gas injected through the injection hole 39b of the gas supply pipe 38 is injected to the workpiece W on the other side. As illustrated in FIG. 2, the plurality of injection holes 39a and 39b of the gas supply pipe 38 is defined with an interval in the Y-direction. Therefore, the cooling gas injected through the injection holes 39a, 39b is injected over the entirety of the workpiece W in the width direction (Y-direction).

As illustrated in FIG. 1, two gas supply pipes 38 are located below each of the upper guide rollers (22a, 22b, 22c), and spaced apart in the z-direction. Further, the two gas supply pipes 38 are located above each of the lower guide rollers 24, and spaced apart in the z-direction. As is clear from FIG. 1, the gas supply pipes 38 are at positions different from where the first heaters (26a, 26b) and the second heaters 28 are positioned. Specifically, the second heaters 28 and the gas supply pipes 38 are alternately arranged with an equal interval in the z-direction (conveying direction). As mentioned above, the processing chamber (19a, 19b) is divided into an upper processing chamber 19a and a lower processing chamber 19b by the workpiece W extending on the guide rollers (22a, 22b, 22c, 24), and the gas supply pipes 38 are arranged in each of the upper processing chamber 19a and the lower processing chamber 19b.

For example, inert gas, nitrogen, Ar gas, etc. can be used as the cooling gas supplied to the gas supply pipes 38. The ambient gas in the processing chamber (19a, 19b) is adjusted by the gas injected into the processing chamber (19a, 19b) from the gas supply pipes 38. In this embodiment, the ambient gas in the processing chamber (19a, 19b) is adjusted to a gas with a dew point of 0° C. or less in order to remove moisture contained in the workpiece W. The cooling gas may be an atmosphere that has a dew point of 0° C. or less.

The controller 44 is configured of a processor including a CPU, ROM, and RAM, and controls the conveyor 20, the heating devices (26, 28), and the gas supply devices. Specifically, the controller 44 controls a conveying speed and tension of the workpiece W by controlling the conveyor 20, controls a heating amount of the workpiece W by controlling the heating devices (26, 28), and controls flow rate and flow speed of the cooling gas injected onto the workpiece W from the gas supply pipes 38 by controlling the gas supply devices.

The heat treatment furnace 10 includes a setting device for setting the workpiece W strapped on the entrance roller 21 onto the exit roller 25. As illustrated in FIG. 1, the setting device has a chain 42 circulating inside and outside the processing chamber (19a, 19b) and a drive device (not illustrated) that drives the chain 42. As with the workpiece W extending on the guide rollers (22a, 22b, 22c, 24), the chain 42 extends from the entrance 15a to the exit 16a while changing its direction upward and downward, and goes back to the entrance 15a from the exit 16a through the outside of the processing chamber (19a, 19b). As illustrated in FIG. 1, the path over which the chain 42 extends intersects the path on which the workpiece W extends (i.e., the conveying path of the workpiece W) at several locations. The position where the chain 42 is located is outside the workpiece W in the width direction (Y-direction), so the chain 42 and the workpiece W do not interfere with each other (see FIG. 2). To set the workpiece W onto the exit roller 25 by the setting device, at first, the workpiece W strapped on the entrance roller 21 is clamped by a clamp (not illustrated) provided on the chain 42. Next, the chain 42 is circulated by the drive unit to feed the workpiece W from the entrance roller 21. As a result, the workpiece W held by the clamp of the chain 42 moves along with the chain 42 in the processing chamber (19a, 19b) toward the exit 16a. When the workpiece W reaches the exit 16a, the clamp is operated to release the workpiece W from the chains 42, and the workpiece W is set onto the exit roller 25. Finally, the workpiece W is put on from the entrance 15a to the exit 16a via the guide rollers (22a, 22b, 22c, 24) by rotating the exit roller 25 and applying tension to the workpiece W.

Next, a process of removing moisture from the workpiece W by using the heat treatment furnace 10 described above will be described. First, cooling gas is supplied to the processing chamber (19a, 19b) from the gas supply pipes 38 to adjust the inside of the processing chamber (19a, 19b) to a predetermined atmosphere. Next, the controller 44 drives the conveyor 20 to convey the workpiece W from the entrance 15a through the processing chamber (19a, 19b) to the exit 16a. At this time, the controller 44 controls the heating devices (26, 28) to radiate infrared electromagnetic waves to the workpiece W and to eject the cooling gas onto the surfaces of the workpieces W from the gas supply pipes 38. When the infrared electromagnetic waves are radiated from the heating devices (26, 28), moisture contained in the workpiece W absorbs the radiated electromagnetic waves, and the moisture evaporates. The moisture evaporated from the workpiece W is removed from the surfaces of the workpiece W by the cooling gas ejected from the gas supply pipes 38. The ambient gas containing the moisture removed from the surfaces of the workpiece W is exhausted out of the processing chamber (19a, 19b) from the exhaust ports 13a of the lower wall 13 and the exhaust ports 14a of the upper wall 14. Moisture is removed from the workpiece W while it is conveyed from the entrance 15a to the exit 16a. The workpiece W, from which the moisture has been removed, is wound onto the exit roller 25.

Here, an example of the measurement results of the heat treatment performance and energy-saving performance when the workpiece W is heat-treated by using the heat treatment furnace 10 of this embodiment will be described using Table 1. As shown in Table 1, with respect to a widthwise dimension of 120 mm of the workpiece W, the heater heating length Hd was changed within the range of 120 mm to 1100 mm, the distance Ld1 from the sidewall 17 to the heating parts 27 was changed within the range of 8 mm to 403 mm, and the distance Ld2 from the sidewall 18 to the heating parts 27 was changed within the range of 20 mm to 605 mm. The total length of the heater was 984 mm, and the effective dimension Td inside the furnace was 1128 mm. Further, the heating time of the workpiece W was set to 15 seconds, and an air intake was adjusted so that the temperature of the workpiece W becomes 150° C. As shown in the results of the experiment, in Comparative Examples 1 and 2, the dehydration rate was 50%, but the energy input to the heaters had to be increased, thus the energy-saving performance decreased. In Comparative Example 3, the energy input to the heater was reduced, but the dehydration rate decreased to 30%. In particular, dehydration was insufficient at the edges of the workpiece W. On the other hand, in Examples 1 to 6, the energy input to the heater was reduced while the dehydration rate was also 30% or higher. In particular, in Examples 3 and 4, the dehydration rate was 50% or higher while the energy input to the heaters was small, and both the high dehydration rate and energy-saving performance were achieved.

TABLE 1

| | Evaluation parameters | | | | | | | | |
|---|---|---|---|---|---|---|---|---|---|
| | | | | Distance between | Distance between | | | | |
| | Heating | Widthwise | | first end of | second end of | | | Entire length | |
| | length of | length of | | heating part and | heating part and | | | of heater | Effective dimension |
| | heate/Hd | workpiece/ | | sidewall/Ld 1 | sidewall/Ld 2 | | | in furnace | inside furnace/ |
| | (mm) | Wd(mm) | Wd/Hd | (mm) | (mm) | Wd/Ld1 | Wd/Ld2 | (mm) | T d(mm) |
| Comparative | 1100 | 120 | 0.109 | 8 | 20 | 15.00 | 6.00 | 984 | 1128 |
| Example 1 | | | | | | | | | |
| Comparative | 900 | 120 | 0.133 | 53 | 175 | 2.26 | 0.69 | 984 | 1128 |
| Example 2 | | | | | | | | | |
| Example 1 | 600 | 120 | 0.200 | 163 | 365 | 0.74 | 0.33 | 984 | 1128 |
| Example 2 | 500 | 120 | 0.240 | 218 | 410 | 0.55 | 0.29 | 984 | 1128 |
| Example 3 | 400 | 120 | 0.300 | 238 | 490 | 0.50 | 0.24 | 984 | 1128 |
| Example 4 | 250 | 120 | 0.480 | 338 | 540 | 0.36 | 0.22 | 984 | 1128 |
| Example 5 | 180 | 120 | 0.667 | 353 | 595 | 0.34 | 0.20 | 984 | 1128 |
| Example 6 | 150 | 120 | 0.800 | 378 | 600 | 0.32 | 0.20 | 984 | 1128 |
| Comparative | 120 | 120 | 1.000 | 403 | 605 | 0.30 | 0.20 | 984 | 1128 |
| Example 3 | | | | | | | | | |

| | Evaluation parameters | | | Results of experiment | | | | |
|---|---|---|---|---|---|---|---|---|
| | Temperature | Amount of | | | Heater | Vent | | |
| | of workpiece | supplied gas | Heating | Dehydration | input | loss | Total | Overall |
| | (° C.) | (Nm³/min) | time (s) | rate (%) | (kW) | (KW) | energy | evaluation |
| Comparative | 150 | 8 | 15 | 50% | 41.5 | 4.09 | 45.59 | x High energy |
| Example 1 | | | | | | | | |
| Comparative | 150 | 7 | 15 | 50% | 39.6 | 3.58 | 43.18 | x High energy |
| Example 2 | | | | | | | | |
| Example 1 | 150 | 6 | 15 | 50% | 26.4 | 3.07 | 29.47 | ◯ |
| Example 2 | 150 | 5 | 15 | 50% | 22.0 | 2.56 | 24.56 | ◯ |
| Example 3 | 150 | 3 | 15 | 50% | 20.6 | 1.54 | 22.14 | ⊚ |
| Example 4 | 150 | 3 | 15 | 50% | 15.4 | 15.44 | 16.94 | ⊚ |
| Example 5 | 150 | 2 | 15 | 40% | 13.4 | 1.02 | 14.42 | ◯ |
| Example 6 | 150 | 2 | 15 | 35% | 10.2 | 1.02 | 11.22 | ◯ |
| Comparative | 150 | 2 | 15 | 30% | 7.4 | 1.02 | 8.42 | Δ 50% or less |
| Example 3 | | | | | | | | dehydration rate; |
| | | | | | | | | heating length of |
| | | | | | | | | heater is too short to |
| | | | | | | | | dehydrate film edges. |

According to the above heat treatment furnace 10, the widthwise dimension of each of the heating parts 27 of the heaters (26a, 26b, 28) is adjusted to be appropriate for the widthwise dimension of the workpiece W. Further, the distance from each of the heating parts 27 of the heaters (26a, 26b, 28) to the sidewall (17 and/or 18) is adjusted to be appropriate. Consequently, the electromagnetic waves radiated from the heating parts 27 of the heaters (26a, 26b, 28) are efficiently used to remove moisture from the workpiece W, by which the dehydration rate of the workpiece W (heat treatment performance of the heat treatment furnace 10) can be improved and the energy-saving performance of the heat treatment furnace 10 can be improved. Furthermore, the inner wall surfaces of the furnace body 12 are suppressed from becoming hot by the electromagnetic waves radiated from the heating part 27, and as a result, the temperature rise of the workpiece W can be suppressed. Consequently, the heat treatment performance and the energy-saving performance of the heat treatment furnace 10 can be improved while the quality deterioration caused by the temperature rise of the workpiece W can be suppressed.

In the above embodiment, the length of the heating part 27 of each of the first heaters (26a, 26b) and the length of the heating part 27 of each of the second heaters 28 are the same, however, the configuration is not limited to such an example. In other words, the length of the heating parts of the heaters can be different depending on the position in the processing chamber. For example, as illustrated in FIG. 1, the first heaters (26a, 26b) are located between the guide rollers (22a, 22b, 22c, 24) and the upper wall 14 or the lower wall 13, while the second heaters 28 are located between the entrance wall 15 and the exit wall 16. As it is apparent from the drawings, the first heaters (26a, 26b) are located close to the upper wall 14 or the lower wall 13, while the second heaters 28 are located away from the entrance wall 15 and the exit wall 16. The length of the heating part 27 of each of the first heaters (26a, 26b) may be shorter than the length of the heating part 27 of each of the second heaters 28 to reduce the heat energy radiated from the heating parts 27 of the first heaters (26a, 26b) in order to suppress heating of the upper wall 14 and/or the lower wall 13 and the temperature rise of the workpiece W. On the other hand, the heat energy radiated from the heating parts 27 of the second heaters 28 may be increased to improve the dehydration rate of the workpiece W.

In the above embodiment, the conveying direction of the workpiece W is switched between the upward direction and downward direction by the guide rollers (22a, 22b, 22c, 24), however, the configuration is not limited to this example. For example, the guide rollers in the processing chamber may be eliminated and a work may be conveyed linearly through the processing chamber from the entrance roller to the exit roller.

In the above embodiments, the length of the heating part 27 of each of the heaters (26a, 26b, 28) is constant, but the length of the heating part may be variable depending on the widthwise dimension of the workpiece W. For example, the length of the heating part may be changed by installing filaments of different lengths and changing the filament(s) to which power is supplied.

Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A heat treatment furnace comprising:
a furnace body including an entrance, an exit and a processing chamber disposed between the entrance and the exit;
a conveyor configured to convey a sheet-shaped object from the entrance through the processing chamber to the exit, the object extending from the entrance to the exit; and
a heating device disposed in a space in the processing chamber in which the object is conveyed and configured to heat the object being conveyed by the conveyor,
wherein
the heating device comprises one or more heaters each including a heating part configured to radiate infrared electromagnetic waves to the object,
the one or more heaters are disposed along a conveying path of the object,
the heating part is disposed parallel to a front or back surface of the object, and extends in a width direction of the object orthogonal to the conveying path, and
when a widthwise dimension of the object is Wd and a widthwise dimension of the heating part is Hd, Wd/Hd is in a range of 0.20 to 0.80.

2. The heat treatment furnace according to claim 1, wherein Wd/Hd is in a range of 0.25 to 0.65.

3. The heat treatment furnace according to claim 1, wherein Wd/Hd is in a range of 0.30 to 0.50.

4. The heat treatment furnace according to claim 1, wherein
the furnace body comprises a pair of sidewalls spaced apart in the width direction,
the heating part comprises a first end disposed near one of the pair of sidewalls and a second end disposed near another of the pair of sidewalls,
when a distance between the first end and the one of the pair of sidewalls is Ld1, Wd/Ld1 is in a range of 0.32 to 0.74, and
when a distance between the second end and the other of the pair of sidewalls is Ld2, Wd/Ld2 is in a range of 0.20 to 0.33.

5. The heat treatment furnace according to claim 4, wherein
Wd/Ld1 is in a range of 0.35 to 0.55, and
Wd/Ld2 is in a range of 0.23 to 0.25.

6. The heat treatment furnace according to claim 1, further comprising a plurality of guide rollers disposed in the processing chamber and configured to guide the object conveyed by the conveyor,
wherein the conveying path is defined by the plurality of guide rollers.

7. The heat treatment furnace according to claim 6, wherein
the object comprises a sheet-shaped film and a paste applied to at least one of a front surface and a back surface of the film, and
the heating device is configured to remove moisture contained in the paste.
